(19) United States
(12) Patent Application Publication
(10) Pub. No.: US 2017/0198855 A1
(43) Pub. Date: Jul. 13, 2017

(54) INTRINSICALLY CONDUCT JOINT FOR METALLIC PIPE AND METHOD OF USING THE SAME

(71) Applicant: Philpott Rubber LLC, Brunswick, OH (US)

(72) Inventors: Michael K. Baach, Medina, OH (US); Gregory Charles Stafford, Medina, OH (US)

(73) Assignee: Philpott Rubber LLC

(21) Appl. No.: 15/375,443

(22) Filed: Dec. 12, 2016

Related U.S. Application Data
(60) Provisional application No. 62/278,240, filed on Jan. 13, 2016.

(51) Int. Cl. F16L 58/18; F16L 21/03; F16L 9/02

(52) U.S. Cl. CPC F16L 58/185; F16L 9/02; F16L 21/03; F17D 5/02

(57) ABSTRACT

A mechanical joint and method for controlling stray current in a buried or submerged pipeline made of ductile iron, cast iron and/or steel that includes a gasket arrangement having an annular gasket body with a radially inward and outward edge portions and first and second longitudinal edge portions, the radially outward edge portion and the radially inner edge portion being generally coaxial with a gasket axis, the radially inner edge portion having an inner engagement surface and the radially outer edge portion having an outer engagement surface, when in an installed condition, the outer surface directly engaging a first pipe and the inner engagement surface directly engaging a second pipe wherein the gasket forms a seal between the first and second pipes, the annular gasket includes an intrinsically conductive polymer material having a resistivity below 700 ohm-cm wherein the gasket provides the seal and electrical conductivity between the pipes thereby allowing stray current to freely pass through the polymer material and between the first and second pipes to reduce and/or eliminate corrosion-induced holes.

This application claims priority to provisional patent application Ser. No. 62/278,240 filed on Jan. 13, 2016, which is incorporated by reference herein.

The invention of this application relates to electrically conductive joints for metallic pipelines and, more particularly, to create electrical conductivity between and among joints by use of an intrinsically conductive gasket arrangement for the joints in metallic pipes that are buried or submerged pipelines that are generally made of ductile iron, cast iron and/or steel. These metallic pipes are coupled together by mechanical means to the create pipelines. The invention also relates to a method of using the same.

### INCORPORATION BY REFERENCE

The invention of this application relates to electrical conductivity between and among joints for metallic pipelines and, more particularly, to create such conductivity by the use of intrinsically conduct gaskets for the joints in metallic pipes that are buried or submerged as pipelines and most often made of ductile iron, cast iron and/or steel. However, this pipes can also be made from copper, aluminum, and stainless steel. These metallic pipes are coupled together by mechanical means to create pipelines. The invention also relates to a method of using the same. The AWWA Standard C111/A21.11-07 relates to Rubber-Gasket Joints for Ductile-Iron Pressure Pipe and Fittings and is incorporated by reference for showing the same and forms part of the specification of this application.

### BACKGROUND OF THE INVENTION

Cast and, more recently, ductile iron pipe have been used extensively for underground waterlines since the 1800's. It was thought that such material would last 50 to 100 years or more because of its corrosion tolerance due to the relatively thick pipe walls. In fact, there are iron pipelines that have lasted well over 100 years. However, where the iron pipe is installed in relatively aggressive environments, failures have been reported to have occurred in 10 or less years, most often due to galvanic or electrolytic corrosion. When the pipe fails, its operator is most often left with only the option to replace large sections of pipe in fear that the location of failure was a precursor to further, more extensive failures. However, many times it is later discovered that only a small length of the pipeline is in need of replacement. And, this failure of only a small length of pipeline can result in significant repair costs.

Currently, it is common practice in the water industry to install polymer gaskets, usually of synthetic rubber, where pipe sections are joined to prevent weeping or leaking of the fluids being carried by the pipe. The current gasket designs are generally effective in providing such a seal between the pipeline joints. However, because conventional gaskets are made of materials that are dielectric, adjacent pipe sections are rendered electrically discontinuous or isolated. Therefore, any electrical current that intentionally or unintentionally travels down a buried or submerged pipeline must conduct, or jump, from one pipe, into the soil and then back onto an adjacent pipe in order to continuously continue down a pipeline to the source of the electric current. In the case of direct current (DC) on a steel pipeline, approximately twenty (20) pounds of metal will be removed by way of corrosion for each year that one (1) ampere of DC current discharges into the electrolyte (soil or water). This becomes a particular problem when a pipeline is buried in the proximity of mines that operate using DC powered equipment or, more likely, near rail transit systems that use DC powered motors. In the case of the transit system that uses one of its rails as the return path to the source of the power that runs the train's motor, experience has proven that a certain amount of current flows into the soil and on to adjacent metal structures, including underground pipelines. This is because electrical current will take all paths of resistance in proportion to their relative conductivity. Simply put, Ohms Law [I Current (amperes)=V (Volts)/R (Resistance)] defines the amount of current that will flow through an electrical circuit. Therefore, where current leaks into the ground, some finds its way onto underground pipelines and usually causes the pipeline to fail due to corrosion if left unabated. Further, in view of lower installation costs, it may be desirable to install pipelines in close proximity to rail transit systems in that the path cut for the rail system is likely cleared of foliage and buildings and thus allows for easier and much less expensive construction for the pipeline. This increases the likelihood that the pipeline will pick up current leaked into the ground from the transit system resulting in vastly premature failure of the pipeline.

When the electrical current moves onto the surface of a pipeline, it will travel along the pipe and will follow the path to return to the stray current power source in proportion to its paths of resistance. As it travels along the pipeline, it will eventually arrive at a mechanical joint between adjacent pipes. If the mechanical joint allows the current to pass to the adjacent pipe via intentional or inadvertent electrical continuity, it will continue through the mechanical joint with little or no damage to the pipeline. Metal-to-metal current flow is “electronic” current flow and this type of current flow does not cause corrosion. However, if the mechanical joint does not allow the current to freely pass to the adjacent pipeline by metal-to-metal contact, the current must take a different path; again based on the proportional paths of least resistance. If a traditional gasket is used in the mechanical joint, the current must travel (jump) through the soil and return to the adjacent pipe due to the extremely high electrical resistance of the elastomeric gasket. Transfer from metal to water or moisture in soil current flow is “electrolytic” current flow and electrolytic current flow or conductance causes corrosion on the pipeline surface. Again, where one (1) ampere of DC current discharges from a steel pipe for a year from electrolytic current conductance, it takes with it approximately twenty (20) pounds of metal. This is what is commonly called “stray current,” “electrolysis” or “electrolytic” corrosion as it is caused by the presence of some external source of DC electricity usually caused by adjacent DC powered equipment such as those used in mines, impressed current cathodic protection systems and, most often, transit systems on rails. If the pipeline is electrically continuous along its length, the current can be drained back to its source by a single electronic bond, thus minimizing or eliminating highly damaging corrosion of the pipeline from electrolytic current conductance. Attempts to weld metal jumper bonds across the pipe joints to establish the necessary electrical continuity have often proven costly and subject to contractor error or post-installation electrical bond material failure.

All metals are subject to a natural oxidation process that follows the laws of nature, which occurs when a metal is in contact with an electrolyte. The electrolyte is normally the water in which the pipe is submerged or moisture in the soil in contact with a buried pipeline. A highly cost effective means of mitigating corrosion on buried pipelines is an electrical process called cathodic protection, which overcomes the natural tendency of a metal to corrode. Often, the most effective and economical means of providing cathodic protection to a pipeline is to impress DC current from a buried electrode (anode) through the soil or water onto the pipe thus overcoming the pipe's tendency to corrode by discharging current. However, for an impressed current cathodic protection system to operate effectively, the pipe must be electrically continuous along its length. If the pipe is not electrically continuous along its entire length, then attempts to use cathodic protection in a pipeline can have the same detrimental corrosion effect as stray current. As is known in the art, if the “electrolysis,” “stray current” or “electrolytic” corrosion is allowed to continue, corrosion-induced holes in the pipeline will eventually form. And, if these holes are not repaired, the pipeline will form leaks.

In view of the significant costs associated with pipe replacement resulting from “electrolysis” or “electrolytic” corrosion, it is commonly understood that the most effective time to establish continuity of a buried pipeline is during pipeline installation. However, prior attempts to establish continuity of a buried pipeline have been found to be costly and often ineffective. Further, some prior attempts have been found to create corrosion points in view of the creation of electrical arc points and from the use of dissimilar materials to create the bonds. An arc point is the relatively high-resistant contact point between the metal bonding component(s) and the pipes in the pipeline. When most or all of the current traveling between adjacent pipes in the pipeline travels by way of a small current path (either in number or size) in the metal bonding component(s), the relatively high circuit resistance can make the metal component(s) heat up in the presence of high current much like a high resistance wire. The heat can then damage the metal component(s) and materials around the component, such as the rubber in the gasket. And, ultimately can become so highly resistant at the metal to pipe boundary that it will create an electrical arc. Because of the relatively high resistance between the metal bonding component and the pipe, this electrical arc can then “jump” to adjacent materials, which includes jumping to the surrounding soil. Moreover, it has been found that when these current paths heat up and arc, these current paths then became non-conductive thereby worsening the jumping of current into the soil.

One such attempt has been the use of insulated jumper wires or straps that are welded or bolted across the mechanical joints. This process is labor intensive and subject to failure for multiple reasons. As can be appreciated, this method creates an extra step for the completion of every mechanical joint in the pipeline. In that there can be thousands of mechanical joints on a single pipeline, this can add significant cost to the overall cost of the project. As can be further appreciated, in view of the added cost associated with the addition of the jumper wires or straps, common practice is to install only one jumper wire or strap at each pipe joint. And, if this single jumper strap fails when stray DC currents are impressed onto the pipe, the pipe will eventually fail due to accelerated corrosion at or near the discontinuous pipe joints and need to be replaced. Yet further, jumper straps failure can be caused in several ways. First, the jumper wire could be defective initially in view of contractor error during its installation to the pipes. As can be appreciated, when thousands of jumper wires are manually welded or bolted along a pipeline, there is an unacceptably high chance that one or more will be installed improperly. And, it takes only one improper installation to break the electronic current flow path across the pipeline joint(s). Second, the jumper wire must be welded or bolted to an outer surface of the pipes wherein there is also a risk of mechanical damage to the jumper wire and/or jumper wire during installation of the pipeline and/or the backfilling of the pipe trench. As can be also appreciated, the jobsites for pipeline installation can be in harsh environments with large equipment and the movement of tons of dirt and gravel to dig and then backfill the pipe trench. Third, the use of welded bond apparatus, and even bolts, can add dissimilar materials to the pipeline when the wire itself, the welding materials and/or the bolts are dissimilar to the iron pipe, which will then create its own form of galvanic corrosion. Fourth, since only a single jumper wire is typically used that can create a current arc point if not installed properly. In that a current arc point is created, it can increase the likelihood that the jumper wires or straps will fail. All current that is impressed on the pipeline must return to its source, often miles away. This is of particular concern if a single bond fails. The corrosion at the electrical arc point created by this failure will concentrate corrosion at that location, especially if all other bonds remain intact and effective.

In view of the inherent problems with bonding pipe joints with jumper wires or straps, other prior art attempts to solve this problem have included gaskets that include adding one or more mechanical, metallic components with the intent of creating metallic current flow paths to the gasket material. Thus, the gasket itself was intended to include one or more current flow paths to electronically conduct electrical current between adjacent pipe sections. These components have included one or more electrically conductive metal components to provide the electrical connection between the adjacent pipes. These can come in the form of metal particles, wedges, tabs, wire or mesh. However, these have not provided an effective outcome. First, in that the gasket is a hidden component, it is difficult to determine for sure if the mechanical current flow components are making effective contact with both pipes. If there is a lack of metal-to-metal contact through the gasket to both adjacent pipes, the current flow path will likely be insufficient to provide the needed electronic conductance. Even when these conductive-metal loaded gaskets provide some measure of electronic conductance, low electronic conductance can result in the lowest or a proportionally more significant path of electrical conductance being the surrounding soil wherein the DC current will still jump into the soil and travel back to the adjacent pipe. Second, the mechanical current flow paths can create a leak point if they prevent the elastomeric material from sufficiently engaging both pipe sections. As can be appreciated, a less aggressive mechanical flow path(s) may not be sufficient to make the needed electronic electrical connection between adjacent pipes if it is urged or buried below the elastomeric gasket's surface, while an overly aggressive mechanical flow path that extends beyond the elastomeric gasket's surface can prevent a good seal. And, the number of mechanical current flow paths must be weighed in view of this tradeoff between a good seal and good conductivity. Third, mechanical flow paths in the gasket can create the current flow arc points noted above. And, it has been found that these mechanical current flow paths can heat up, arc and then became non-conductive. Yet further, these arc points create heat that can damage the rubber in the gasket and create additional leaks. And, even if multiple mechanical paths are created, there is always the possibility that less than all of them will make electrical contact between the adjacent pipe sections. As a result of these shortcomings, significant pipe corrosion and premature pipe failure results, especially when the pipe was installed in relatively low resistivity soils.

Accordingly, past attempts to create conductive mechanical joint devices have been ineffective wherein there remains a need in this industry for a solution to this problem. In this respect, even with these prior designs it is reported that 6 billion gallons of potable water are “unaccounted for” daily in the United States alone and that this is primarily due to leaks. And, that it is understood in this industry that many or most of these leaks are due to corrosion. Moreover, even though the loss of billions of gallons of water is very expensive and it is also very expensive to fix these leaks after installation, there is still no adequate solution to this problem in the industry. Accordingly, there is a significant need in the industry to reduce “electrolysis,” “stray current” or “electrolytic” corrosion through effective electrical bonding of mechanical joints and prior attempts have been ineffective.

### SUMMARY OF THE INVENTION

The invention of this application relates to a mechanical joint between adjacent buried pipes that prevents stray current from exiting the pipeline into the surrounding soil or water while still providing an effective seal between the pipeline joints. More particularly, the invention relates to a gasket arrangement that has non-mechanical, electronic current flow paths wherein the gasket itself is intrinsically conductive and; more particularly, to an intrinsically conduct gasket for metallic pipes that are buried or submerged as pipelines and made of ductile iron, cast iron and/or steel. These metallic pipes are coupled together by the mechanical joint to create pipelines.

More particularly, the invention of this application relates to a mechanical joint that can establish electrical continuity along long runs of ductile or cast iron pipelines as a part of a properly engineered pipeline life extension program. Moreover, the mechanical joint provides electrical continuity about substantially all of the annular contact surface between adjacent pipes, which reduces ineffective conductivity and electrical arc points.

According to certain aspects of the invention, provided is an intrinsically conductive polymer to form a gasket primarily intended for use on bell and spigot (push-on joint assembly) pipes.

According to another set of aspects of the invention, provided is intrinsically conductive polymer gaskets generally in range of between 3 inches and 84 inches in diameter.

According to another aspect of the invention, the compound resistivity of the mechanical joint of this application can be varied and then held consistent for each individual pipeline project. Thus, the life extension in years between a pipeline using the invention of this application and one using prior, practically non-conductive technology can be calculated during the pipeline design phase. The ability to vary the compound resistivity provides significant flexibility to the pipeline design engineer. In this respect, varied compound resistivity, which is not available in the prior art, allows specification of the gasket of this application for compatibility with project specific factors, such as measured and anticipated stray DC earth current variables. Moreover, varied compound resistivity allows the pipeline engineer to design capabilities over the gasket conductance, which otherwise would be an uncontrollable pipeline operating variable. As a result, added pipeline life expectancy due to stray DC current mitigation can be established during the design phase of the pipeline with a much increased level of confidence. Moreover, pipeline life expectancy is significantly increased.

According to yet other aspects of the invention, provided is a mechanical joint that can also be used for cathodic protection systems.

According to further aspects of the invention, provided is a method of protecting from corrosion of a pipeline by providing a conductive mechanical joint between adjacent buried pipes that prevents stray current from exiting the pipeline thereby preventing corrosion-induced holes from forming in the pipeline while still providing an effective seal between the pipeline joints.

According to certain aspects of this method, this is achieved by providing a mechanical joint that includes a gasket arrangement that has non-mechanical, nearly continuous electronic current flow paths wherein the gasket itself is intrinsically conductive.

More particularly, the invention of this application relates to a mechanical joint that can establish electrical continuity along long runs of ductile or cast iron pipelines as a part of a properly engineered pipeline life extension program. Moreover, the mechanical joint provides electrical continuity about substantially all of the annular contact surface between adjacent pipes, which reduces ineffective conductivity and electrical arc points.

According to certain aspects of the invention, provided is a method of using an intrinsically conductive polymer to form a gasket primarily intended for use on bell and spigot (push-on joint assembly) pipes and to allow a free flow of electrical current through the pipeline without current jumping through the soil between adjacent pipes.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 is an elevational view of a pipeline having a mechanical joint according to certain aspects of the present invention;

FIG. 2 is an elevational view of the pipeline shown in FIG. 1 that includes a depiction of a stray current;

FIG. 3 is the elevational view of the pipeline shown in FIG. 2 that includes a depiction of a stray current and a non-conductive joint;

FIG. 4 is a perspective view of a pipe in a pipeline being installed;

FIG. 5 is a perspective view of a mechanical joint prior to the assembly of an adjacent pipe;

FIG. 6 is a sectioned view of an installed mechanical joint for two adjacent pipe sections;

FIG. 7 is an enlarged view taken from FIG. 6 showing another gasket arrangement fitted between two adjacent pipe sections forming the mechanical joint;

FIG. 8 is an enlarged view taken from FIG. 6 showing yet another gasket arrangement fitted between two adjacent pipe sections forming the mechanical joint;

FIG. 9 is a perspective view of a gasket;

FIG. 10 is a sectional view taken along line 10-10 in FIG. 9;

FIG. 11 is an enlarged view taken from FIG. 10 showing a cross sectional view;

FIG. 12 is an enlarged view taken from FIG. 10 showing a cross sectional view; and,

FIG. 13 is a table showing the increased life expectancy of the mechanical joint according to certain aspects of the invention.

### DESCRIPTION OF PREFERRED EMBODIMENTS

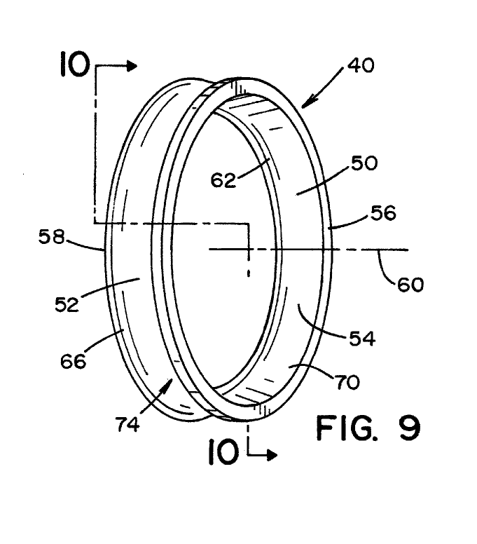

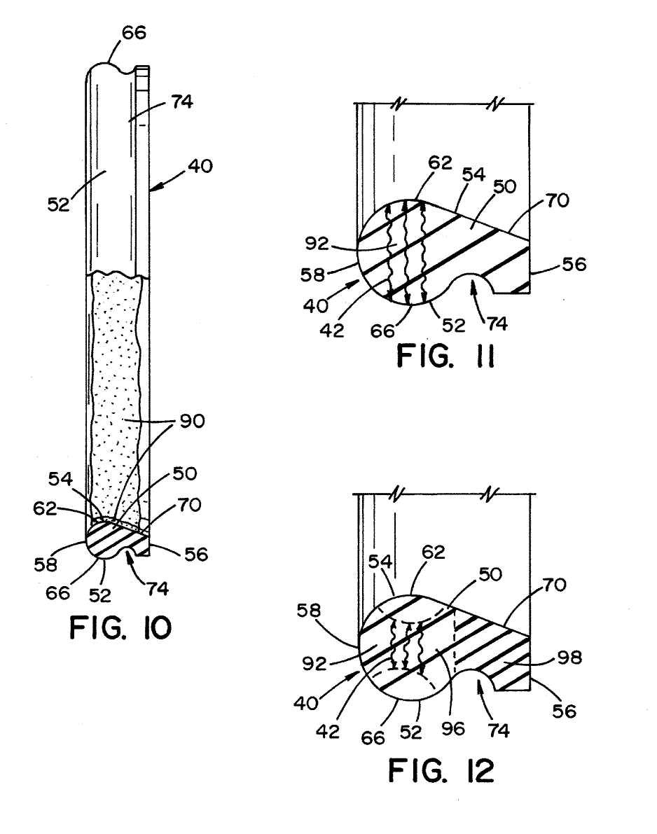

Referring now to the drawings wherein the showings are for the purpose of illustrating preferred and alternative embodiments of the invention only and not for the purpose of limiting the same, FIGS. 1-12 show a pipeline 10 that extends between a first extent 12 and a second extent 14. The pipeline is formed by a plurality of pipes 20 that are joined together at mechanical joints 30. As is shown in FIG. 1, pipeline 10 includes a pipe 20a at or near first extent 12, pipe 20b at or near second extent 14 and with pipes 20c-20e in a pipe section 22. Pipe section 22 also includes mechanical joints 30a and 30b.

Pipeline 10 is a buried pipeline that can be made of ductile iron, cast iron and/or steel. These metallic pipes 20 are coupled together by mechanical joints 30 to create pipeline 10 and to allow a flow of liquid L, typically potable water, from first extent 12 to second extent 14. As can be appreciated, any pipeline configuration could be a part of the invention of this application wherein FIG. 1 is intended to be illustrative only and not limiting.

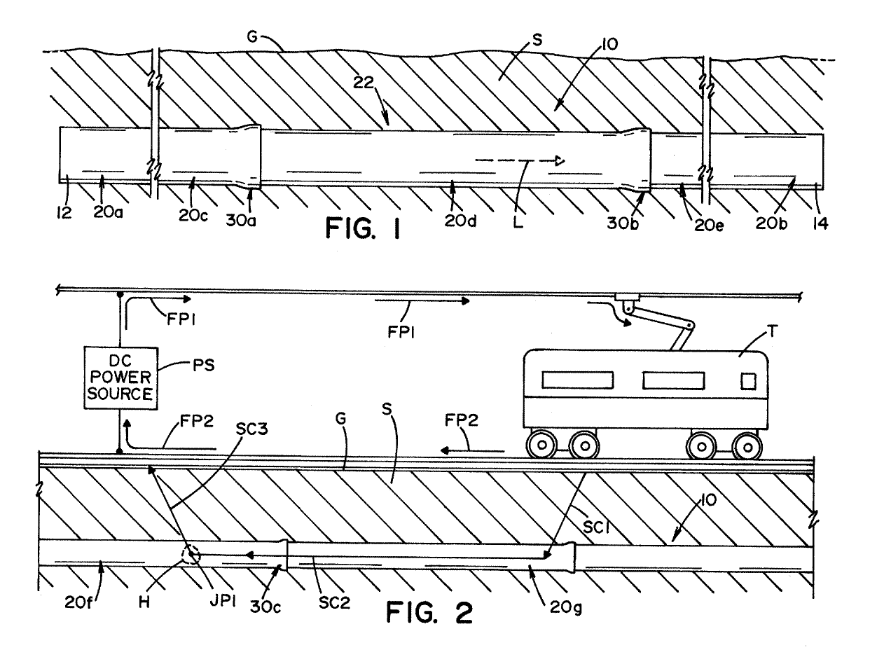

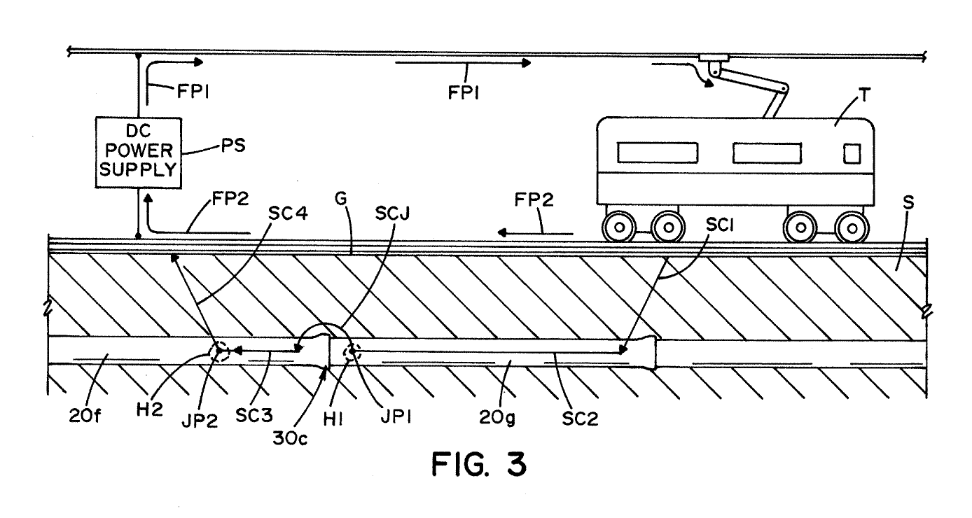

The invention of this application relates to mechanical joints 30 between adjacent buried pipes, and methods relating to these mechanical joints that have been found to significantly increase the expected lifespan of the pipes in the pipeline without adversely creating leaks. In particular, the invention of this application has been found to significantly reduce the effects of a stray current SC on pipeline 10. As is shown in FIGS. 2 and 3, stray current SC can originate from a wide range of powered equipment, such as from a DC powered train T, and the stray current can travel through soil S to enter pipeline 10. In greater detail, train T is powered by a DC power supply PS and the DC power travels along a first flow path FP1 toward train T. The DC power then enters train T and powers a DC motor to drive train T. The DC power then exits Train T and must travel back to power supply PS. The flow is intended to flow along a second flow path FP2 that can be a rail in the train track. While FP2 is intended to be insulated from soil S, the DC current can jump into the soil and create stray current SC. As is shown in FIGS. 2 and 3, stray current SC1 flows away from FP2 and flows into soil S. Stray current SC1 must continue to travel through soil S until it reaches power supply PS or at least re-joins flow path FP2. But, stray current SC1 will follow the path of least resistance as it travels through soil S. Depending on the soil resistivity, stray current SC1 can, and often does, reach pipeline 10. In that pipeline 10 is made from a conductive material, pipeline 10 will form the path of least resistance and SC1 will enter pipeline 10 and travel along pipeline 10 as stray current SC2. As long as SC2 can run along pipeline 10, it will continue to flow along the pipeline and will not cause damage. However, if SC2 exits pipeline 10, the exiting stray current SC3 will remove material depending on how much current flows off of pipeline 10 at a jump point JP. As is discussed above, twenty (20) pounds of metal will be removed from pipeline 10 at jump point JP by way of corrosion for each year that an ampere of DC current discharges into the soil (or water). As can be appreciated, the removal of 20 pounds of metal can and will quickly create a corrosion-induced hole H in pipeline 10.

With special reference to FIG. 2, shown is a first scenario for when stray current SC1 reaches pipeline 10. In this first scenario, stray current SC2 travels through pipeline 10 wherein there are one or more mechanical joints 30 that are electrically conductive. In this scenario, there are no jump points in the pipeline itself except for a single jump point JP1 where the stray current exits the pipeline to travel as SC3 back to power supply PS. And, this single jump point could be controlled by forming a controlled electrical take off that could be electrically connected between pipeline 10 and power supply PS. In this respect, when current SC2 travels through or along pipe 20g and reaches joint 30c between pipes 20g and 20f, if joint 30c is electrically conductive for any reason, stray current SC2 will flow electronically directly between the adjacent pipes without any damage to the pipeline. In that stray current SC2 will follow the path of least resistance, it will not jump from pipe 20g to 20f by way of soil S if joint 30c is the path of least resistance. As a result, no metal of pipeline 10 will be removed as described above at joint 30c.

With special reference to FIG. 3, shown is a second scenario wherein the same stray current of FIG. 2 enters pipeline 10, but where one or more of the mechanical joints 30 in pipeline 10 are electrically non-conductive. In this scenario, there are multiple jump points JP1 and JP2 along the length of pipeline 10. In this respect, if stray current SC2 reaches joint 30c and joint 30c is non-conductive for any reason, stray current SC2 will follow the path of least resistance and will likely jump from pipe 20g at JP1 into soil S as stray current SCJ. If the path of least resistance takes stray current SCJ back into pipeline 10, stray current SCJ will then re-enter the pipeline at pipe 20f and form stray current SC3. As a result, the metal of pipe 20g in pipeline 10 will be removed at JP1 as described above wherein a corrosion-induced hole H1 could be produced in pipe 20g. Then, stray current SC3 will again travel along pipeline 10 as described above and will eventually exit the pipeline at JP2 wherein the exiting current will also cause a corrosion-induced hole H2 where the stray current exits the pipeline to travel as SC4 back to power supply PS. As can be appreciated, the strength of SC may not change even though it has left and re-entered the pipeline wherein corrosion-induced holes H1 and H2 could be similar. And, if there are more non-conductive joints between where the stray current enters the pipeline and where it exits the pipeline, there could be many corrosion-induced holes H that form in the pipeline. As can be also appreciated, these pipelines can be very long and stray current can create significant damage if it is not controlled.

While prior art devices have attempted to control the flow of stray current SC, it has been found that many of the systems used have been ineffective and that these prior art system create their own problems.

The invention of this application relates to a pipeline 10 that includes a gasket arrangement 40 that both provides excellent sealing qualities, but which also provides non-mechanical internal current flow paths 42 that extend about essentially all of the annular gasket between adjacent pipes. By having non-mechanical electrical flow paths 42 wherein the gasket itself is intrinsically conductive, there are no current arc points created and there are no fluid leak points created. DC current on the pipeline will flow substantially from one pipe to the next through the gasket itself and there are no leak points produced from current jumping into the soil. Further, by having a gasket that is intrinsically conductive, current can flow about the entire joint wherein at least some of the gasket will provide current flow paths 42 even if a portion of the gasket is damaged. Yet even further, by allowing the stray current flow to be more evenly distributed about the entire gasket, the stray current is less likely to jump from the pipe into the soil regardless of the soil resistivity. Even yet further, the use of intrinsically conductive gasket material for gasket 50 allows gasket 50 to use any of the existing dimensional gasket designs that are used in the industry today without the need to re-tool pipes 20 of pipeline 10, some of which will be described more below. Again, it must be noted that the description of this application is intended to be descriptive and not limiting wherein some, but not all, of the existing joint designs are described herein. However, the invention of this application is not to be limited to these particular designs wherein it can be used in any buried or submerged pipe design currently known and/or which will be discovered in the future.

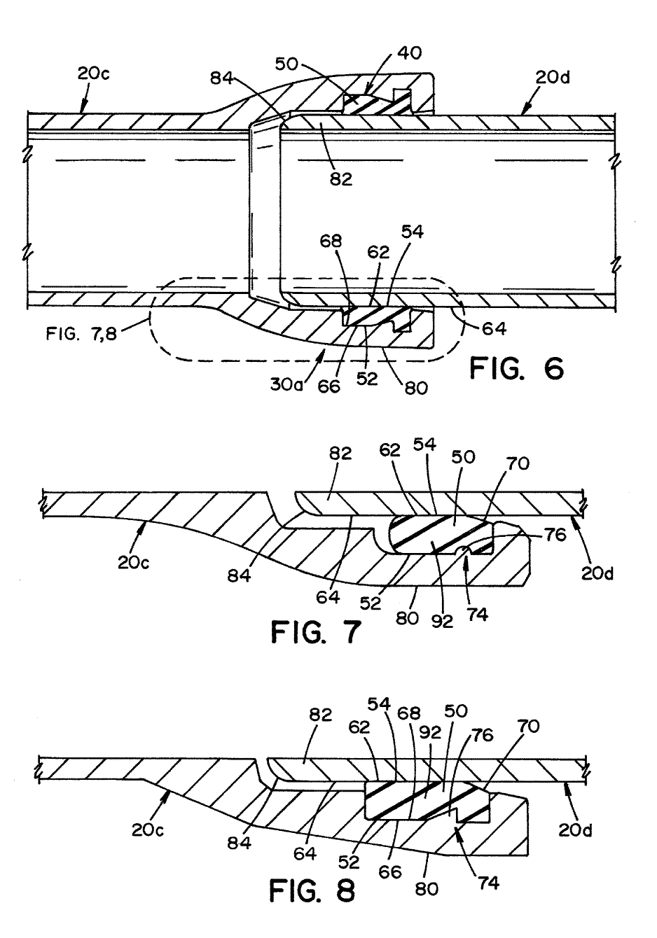

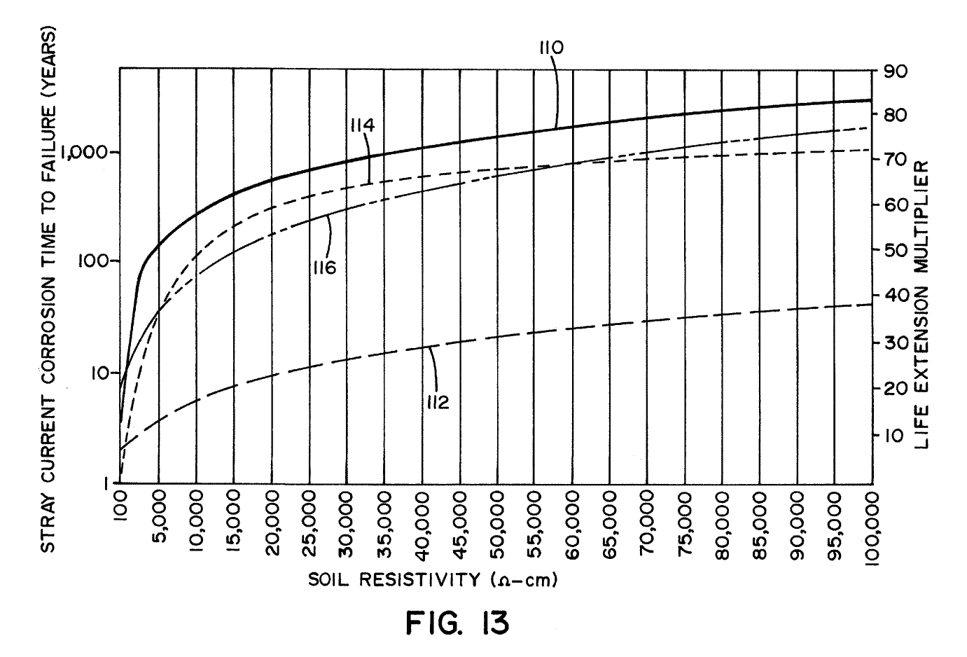

In greater detail, and with reference particular reference to FIGS. 5-12, gasket arrangement 40 includes an annular gasket 50 having a radially outward edge portion 52, radially inner edge portion 54, a first longitudinal edge portion 56 and a second longitudinal edge portion 58. In the embodiments shown, radially outward edge portion 52 and radially inner edge portion 54 are generally coaxial, but some or all of these edges are not exactly coaxial, with a gasket axis 60 wherein gasket 50 as a whole is generally coaxial with axis 60 wherein it is an annual gasket extending about axis 60. As noted above, the invention of this application can work with any joint 30 configuration without detracting from the invention of this application. Further, inner edge portion 54 includes an inner sealing and electrical engagement region, surface or surfaces 62 that engage an outer surface 64 of pipe 20d when pipe joint 30a is in the installed condition as is best shown in FIG. 6. Similarly, outward edge portion 52 includes an outer sealing and electrical engagement region, surface or surfaces 66 that engage an inner surface 68 of pipe 20c when pipe joint 30a is in the installed condition as is shown in FIGS. 5 and 6. As is best shown in FIG. 12 as compared to FIGS. 7 & 8, this can be a region that will change shape and deform when in engagement with the pipes and which will change shape to both provide a sealing surface and an electrical engagement surface that can be one and the same.

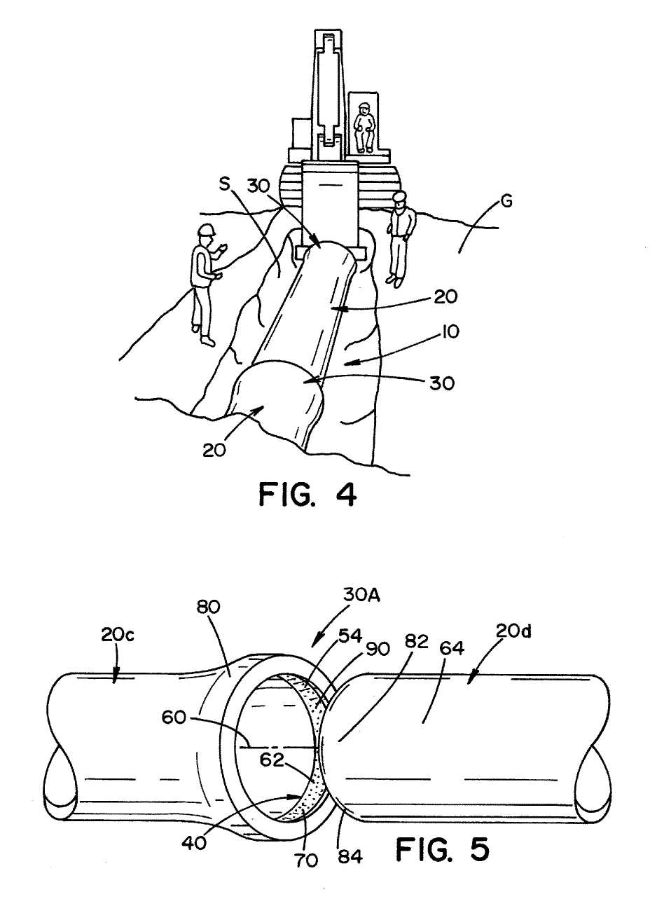

Gasket 50 can further include a lead in taper 70 that allows the joint to be pushed together as is shown in FIG. 4. Gasket 50 can further include a locking flange arrangement 74 that can work with a corresponding locking arrangement 76 of pipe bell end 80 of pipe 20c to prevent movement of gasket 50 relative to pipe 20c when pipe 20d is pressed into position. However, it should be noted that the locking flange arrangement and corresponding locking arrangement could be on either portions of the pipe. In the embodiment shown, pipe 20d has a pipe end 82 and gasket 50 is shaped to receive this pipe end. In particular, sealing and electrical engagement surface 62 of inner edge portion 54 of gasket 50 is shaped to receive pipe end 82 and engage pipe surface 64. Moreover, and as is known in the art, tapered portion 70 of inner edge portion 54 helps direct end 82 into mating engagement between end 82 and gasket 50. Moreover, pipe end 82 can further include, or be modified to add, a pipe taper 84 to also direct end 82 into mating engagement between end 82 and gasket 50. In addition to the tapers in the gasket and the pipe end, gasket arrangement 40 can further include a gasket lubricant 90 to help pipe end 82 push into gasket 50 without gasket movement and/or damage. Yet further, the lubricant used to improve the push in of the pipe can be formulated to further increase the electrical conductivity between the adjacent pipe sections.

Gasket 50 includes an intrinsically conductive polymer 92 so that the some or all of the gasket can act as an electric conductor wherein it forms flow paths 42 therein. As a result, any stray current SC in pipe section 20d would pass freely to pipe section 20c about at least a large portion of the gasket wherein flow paths 42 freely direct any stray current SC between sealing and electrical engagement surfaces 62 and 66, which provides a widely dispersed current flow within polymer 92. In fact, the electrical connection between the adjacent pipe sections would be transferred through a substantial portion of contact surfaces 62 and 66 by the engage between the contact surfaces and the corresponding pipe surfaces. Accordingly, there is no individual point contact for the electrical conductivity, there are no arc points, the electrical conductivity can take place about any circumferential point of the gasket arrangement and damage to a portion of the gasket is less likely to eliminate the electrical conductivity between adjacent pipe sections. Yet further, by providing dispersed current flow about a substantial portion of the annular gasket, smaller current will be present at any one location about the mechanical joint thereby reducing arc points and reducing the likelihood of a current jump at the joint.

As will be discussed more below, the electrical conductivity of gasket 50 can be determined and/or modified by local conditions such as the type of potential stray current and the soil resistivity. While a traditional gasket typically has a resistivity of over 5,000 ohm-cm, gasket 50 can ideally include a resistivity below 100 ohm-cm. In a preferred set of embodiments, gasket 50 includes a resistivity in the range of 1 to 700 ohm-cm. More preferably, gasket 50 includes a resistivity in the range of 1 to 550 ohm-cm. Even more preferably, gasket 50 includes a resistivity in the range of 1 to 400 ohm-cm. Yet even more preferably, gasket 50 includes a resistivity in the range of 1 to 200 ohm-cm. Even yet more preferably, gasket 50 includes a resistivity in the range of 1 to 100 ohm-cm. in the embodiments shown, gasket 50 includes a resistivity of about 70 ohm-cm.

With reference to Table I below, shown is the Life Extension Multiple that has been found for the gasket arrangements of this application. The Life Extension Multiple is the amount of times longer a pipe in a pipeline would last with the invention of this application as compare to a prior art polymer gasket that has a resistivity of about 5,390 ohm-cm. In this respect, a Life Extension Multiple of 2 would mean that a buried pipe utilizing the gasket of this application would last twice as long as a pipe with a prior art polymer gasket. A Life Extension Multiple of 4 would mean that a buried pipe utilizing the gasket of this application would last four times as long as a pipe with a prior art polymer gasket. In Table 1, this Life Extension Multiple has been calculated based on the preferred embodiments wherein material 92 has a resistivity of 75 ohm-cm in gasket 50 and is installed in soil having a resistivity of 10,000; 100,000; and 1,000,000. It has been found that a gasket 50 having material 92 with a resistivity of 75 ohm-cm can provide seventy times the life expectancy in the presence of 10 amperes of continuous DC current. In greater detail, if soil S has a soil resistivity of 10,000 ohm-cm, gasket 50 would have a Life Expectancy Multiple of forty-seven wherein it would last forty seven times as long as a prior art polymer gasket. If gasket 50 is used in a pipeline that is buried in soil S having a soil resistivity of 100,000 ohm-cm, the Life Expectancy Multiple is sixty eight times that of a prior art polymer gasket. If gasket 50 is used in a pipeline that is buried in soil S having a resistivity of 1,000,000 ohm-cm, the Life Expectancy Multiple is seventy one times that of a prior art polymer gasket.

TABLE 1

| | | Calculated Life |
|---|---|---|
| | Gasket Resistivity | Extension Multiple |
| Soil | Needed for 10× Life | with 75 ohm-cm |
| Resistivity | Extension Multiple | gasket |
| 10,000 | 375 | 47 |
| 100,000 | 500 | 68 |
| 1,000,000 | 550 | 71 |

As can been seen from Table I above, gasket 50 according to the invention of this application can drastically increase the life of one or more of the pipes 20 in the pipeline. It has been found that a gasket 50 having material 92 with an electrical resistivity of less than 550 ohm-cm will provide a Life Extension Multiple of at least ten (ie: pipes 20 would last at least ten times as long) as compared to conventional polymer gaskets with a constant electrical resistivity of 5,390 ohm-cm for most soil types. A gasket 50 having an electrical resistivity of less than 75 ohm-cm can increase pipe life by up to seventy times as compared to conventional polymer gaskets.

Further, and with reference to the table below, it has also been found that the advantageous properties described above can also be achieved with a gasket that also meets the ANSI Specification wherein the gasket further has the properties of Table II below and which can be formed into currently utilized gasket configurations. Yet further, this can include intrinsically conductive polymer 92 being used in inner sealing and electrical engagement surfaces 62, outer sealing and electrical engagement surfaces 66 and extending therebetween to produce a conductive portion or region 96 of gasket 50. This region can be purely a more conductive region and/or a better sealing region for the gasket seal and can be separate form a more structural region 98 that can be produced by a different material, such as being produced with a higher durometer material in accordance with certain portion of the ANSI Specification.

TABLE II

| | ASTM | Main Body of Gasket | | Harder Portion (If Used) | |
|---|---|---|---|---|---|
| | Test | Standard | | Standard | |
| Property | Method | (US) | Metric | (US) | Metric |
| Norminal hardness, shore “A” | D2240-91 | 50-65 | 50-65 | 80-85 | 80-85 |
| Tolerance on nominal hardness | | ±5 | ±5 | ±5 | ±5 |
| Minimum ultimate tensile | D412-92 | 2,000 psi | 14 MPa | 1,200 psi | 8 MPa |
| Minimum ultimate elogation* | D412-92 | 300% | 300% | 125% | 125% |
| Minimum aging^{†} | D572-88^{‡} | 60% | 60% | — | — |
| Maximum compression set | D395-89 | 20% | 20% | — | — |
| | Method B | | | | |
| Resistance to surface ozone | D1149-91^{§} | No cracking | | — | — |
| cracking | | | | | |

*Of original length.
^{†}Of original values of tensile and ultimate elogation.
^{‡}Oxygen pressure method; after 96 hr at 70° C. ± 1° is 500 psi ± 10 (2,068 kPa ± 69).
^{§}After a minimum of 25-hr exposure in 50-pphm more concentration at 104° F. (40° C.) on a loop-mounted gasket with approximately 20 percent elongation at outer surface.

Gasket 50 can be designed and used in a wide range of pipe systems including, but not limited to, a wide range of bell and spigot (push-on joint assembly) pipes as is described above. Further, gasket 50 can be made in a wide arrange of gasket configurations (existing and new) without detracting from the invention of this application, which is best shown in FIGS. 6-8 wherein these figures show examples of different gasket configurations. Yet further, the gaskets can be made in a wide arrange of sizes, which will be discussed more below, wherein the invention of this application can be utilized in pipelines of all known configurations and/or sizes including, but not limited to, those in the range of 3 inches and 84 inches in diameter.

According to another important aspect of the invention, by removing the mechanical electrical connectors and utilizing an intrinsically conductive compound for gasket 50, the compound resistivity of flow paths 42 in the gasket of this application also can be varied based any variable relating to the pipeline. As discussed above, the resistivity can be varied and held to a wide range of values and these can be set based any factors relating to the environment that the pipeline will travers. Yet even further, the gaskets of a pipeline even can have different properties within different sections of the pipeline as the pipeline passes through different soil types and different levels of potential stray current, which was not heretofore possible. Then, once a preferred compound resistivity is determined (either for the pipeline or a section of the pipeline), it can be held consistent for each individual pipeline project and/or section of the pipeline project. Thus, the life extension in years between a pipeline using the invention of this application and one using prior technology can be calculated during the pipeline design phase. The ability to vary the gasket compound resistivity provides significant flexibility to the pipeline design engineer. In this respect, varied compound resistivity, which is not available in the prior art, allows specification of the gasket of this application for compatibility with project specific factors, such as stray DC earth current variables. Moreover, varied compound resistivity allows the pipeline engineer to design capabilities over the gasket conductance, which otherwise would be an uncontrollable pipeline operating variable. As a result, pipeline life expectancy can be established during the design phase of the pipeline with a much increased level of confidence since electrical bond wire or strap installation error or defect is virtually eliminated. Moreover, pipeline life expectancy is significantly increased.

As can be appreciated, mechanical joint 30 of this application also can be used in connection with cathodic protection systems. Moreover, the benefits of the dispersed current flow of the gasket will also benefit the current flow in the cathodic protection system.

Accordingly, the mechanical joint of this application can be used as a method of protecting a pipeline by both providing an electrically conductive mechanical joint between adjacent buried pipes, by providing the needed sealing qualities between the pipe sections and by providing the needed current passage between adjacent pipe section in a single component of the mechanical joint between adjacent pipes. Further, damage to the conductive gasket is unlikely since it looks and is installed exactly as the prior art gaskets which pipeline contractors have employed for decades. And, the mechanical joint is less likely to reduce any of these qualities in view of the non-mechanical dispersed current flow about substantially all of the gasket and not just spaced mechanical current flow devices.

With reference to FIG. 13, because the low resistivity of gasket 50 is a constant that is created when the polymer is compounded, a pipeline life extension model can be created and is shown in this figure. When populated with certain critical and measureable variables, including the magnitude of stray DC current expected to be picked up by the buried pipeline, a Life Extension Multiple between a pipeline installed in the same environment with gasket 50 versus standard polymer gaskets can be calculated. As shown in FIG. 13, a graph can be generated using the model where the R-squared of the calculated data to the fitted regression line is approximately 0.89. R-squared is a statistical measure of how close the calculated data is to the fitted regression line. It is also known as the coefficient of determination, or the coefficient of multiple determination for multiple regression. An R-squared of 1 indicates that the regression line perfectly fits the data. The equation derived to create the fitted regression line is expressed as follows:

y=(15.17*ln(x))+20.95

where:
x=soil resistivity in ohm-centimeters, and
y=result: multiple of life expectancy using gasket 50 versus standard gaskets

The life extension formula is derived from comparing the predicted life of a pipeline using a standard gasket to one using arrangement 40, which are calculated from the following formula:

Corrosion Life=(Rₛₒᵢₗ/(Rₜₒₜₐₗ)*I*A*D*CR*T

where:
Rₛₒᵢₗ=soil resistivity (Ω-cm)
Rₜₒₜₐₗ=soil resistivity+gasket resistivity (0-cm)
I=continuous current flow on pipe (DC amperes)
A=area of DC current discharge into soil (int)
(assume same area as gasket contact to one pipe wall)
D=pipe density (lbs./int)
CR=corrosion rate of metal (lbs./DC ampere/year)
T=time (years)

The graph of FIG. 13 is based on a nominal 12 inch diameter ductile iron pipe and ten amperes DC continuous current flow. FIG. 13 shows the ductile iron pipe (“DIP”) Life Extension in Stray DC current Zones wherein line 110 shows gasket arrangement 40 life (in years), line 112 shows a conventional non-conductive gasket life (in years), line 114 shows a Life Extension Multiple (right axis) and line 116 shows Log (Life Extension Multiple (right axis).

FIG. 13 shows the extreme difference in life expectancy between a pipe system 10 with mechanical joints 30 with gasket arrangements 40 and an electrically non-conductive conventional gasket. FIG. 13 assumes that there is a continuous flow of the ten amperes of DC current flow. Further, FIG. 13 is based on gasket 50 having a resistivity of 71 ohm-cm and the conventional non-conductive gasket having a resistivity of 5,390 ohm-cm. As is shown, the life predictions of pipeline according to the invention of this application is much greater than that of conventional gaskets as functions of surrounding soil resistivities. A comparison of these predicted lives results in the Life Extension Multiplier value.

It must be noted that although the installation of invention of this application can further increase the life of a buried pipe due to resultant mitigation of long-line, naturally occurring galvanic corrosion cells, such benefit is not included in the mathematical models described herein.

The invention of this application utilizes an intrinsically conductive polymer 92 to at least partially produce gasket 50 wherein the preferred polymeric compound is sufficiently conductive to allow the vast majority of any electrical current on the pipeline to travel electronically across the adjacent pipe joints through flow paths 42 within the gasket material itself rather than electrolytically between the adjacent pipe joints by jumping through the surrounding soil. In particular, and with special reference to FIG. 12, gasket 50 includes surface 62 and 66 that are both sealing surfaces and electrical engagement surfaces where a large portion (can be a substantial portion or substantially all) of radially outward edge portion 52 and radially inner edge portion 54 both seal and electrically conduct stray current wherein a substantial portion of region 96 can be utilized as an electrical conductor between pipes and also form the seal between these pipes. As can be appreciated, region 96 can be the entire gasket wherein region 98 is an alternative embodiment only. Further, since the gasket of this application can be manufactured using any gasket and mechanical joint design, the installation contractors are already experienced and trained to install the pipe gaskets of this application. Yet even further, in that the gasket provides the electrical conductivity, there is no need to install mechanical bonding devices, such as jumper wires or straps. Accordingly, there is no measurable incremental installation costs added to the project for installing the mechanical joint of this application. Moreover, the design of the gasket of this application is very tolerant to the generally harsh installation environments associated with the installation of an underground pipeline wherein damage that breaks the gasket-provided electrical conductivity between pipe sections is essentially impossible. The invention provides the added benefit of allowing the pipeline's owner/operator to delay the installation of Cathodic Protection into the future since the pipeline already is electrically continuous.

According to other embodiments of the invention, provided is a method of installing an underground pipeline including the steps of:

Providing gasket 50 that is formed by an intrinsically conductive polymer 92 to form a gasket having at least a portion of the gasket including internal flow paths 42 wherein the gasket is primarily intended for use on bell and spigot (push-on joint assembly) pipes and to allow a free flow of electrical current through the pipeline without current jumping between adjacent pipes. The gasket dimensions being in accordance with the manufacturer's standard design dimensions and tolerances. The gasket being of a size and shape to provide an adequate compressive force against the plain end and socket after assembly to effect a positive seal under all combinations of joint and gasket tolerances and which provides the needed engagements between sealing and electrical engagement surfaces 62 and 66 and the corresponding pipes;

Cleaning the groove and the bell socket of pipe 20c;

Cleaning the plain end of mating pipe 20d.

Inserting gasket 50 into the bell end of pipe 20c;

Installing gasket 50 into the bell socket of pipe 20c, making sure the gasket faces the correct direction and that it is properly seated in the groove of bell socket of pipe 20c:

Apply lubricant 90 to exposed and sealing surface 62 of gasket 50 in accordance with the pipe manufacturer's recommendations;

Beveling pipe end 82 of pipe 20d as needed per the manufacturer's recommendations to form bevel or lead in 84;

Pushing plain end 82 of pipe 20d into the bell end 80 of pipe 20c keeping the joint straight while pushing.

Making any needed deflection after the joint is assembled.

While small pipes can be pushed into the bell socket with a long bar. Larger pipes can requires additional power, such as a jack, lever puller, or backhoe.

The method described above can further include providing a gasket 50 that includes a resistivity in the range of 1 to 700 ohm-cm. More preferably, gasket 50 includes a resistivity in the range of 1 to 550 ohm-cm. Even more preferably, gasket 50 includes a resistivity in the range of 1 to 200 ohm-cm. Even yet more preferably, gasket 50 includes a resistivity in the range of 1 to 100 ohm-cm.

Yet even further, it has been found that the gasket of this application can be manufactured using existing or manufacturing techniques not yet realized in this industry. As is referenced above, the gasket of this application can be used in connection with a wide range of pipe sizes. These can include traditional sizes (and others) that are in the range of 3 inches to 84 inches in diameter. And, while many of these gaskets have a different diameter, they may include the same cross-sectional configuration and examples of these cross-sectional configurations are shown in FIGS. 6-8 and 10-12. Thus, it has been found that the gasket of this application can be extruded with an extrusion profile of the desired configuration, cut to a desired length, and then spliced endless into an annular gasket. This can allow a single extruded polymer to be inventoried for a wide range of pipe diameters thereby greatly reducing inventory sizes for many of the pipes used in the field. As can be appreciated, gaskets for higher volume pipe diameters could be manufactured using traditional compression, transfer or injection molding processes in addition to this extrusion technique. Furthermore, tooling required to process an extruded profile is traditionally less expensive than the tooling required for compression, transfer or injection molding, thus reducing the cost of the manufacturer to begin producing gaskets. Additionally, when the molding process is used, each individual gasket size requires its own unique mold or mold cavity. In contrast, a single extrusion die can produce a profile that can be extruded in a continuous length, cut to any desired length and splice endless to create the desired gasket diameter. It is common for the gaskets to be marked with size, country of origin, manufacturing date, manufacturer name and other identification. These markings can be molded into the gasket when using the compression, transfer or injection molding processes. However, when the extrusion process is utilized, these markings can be added as a secondary printing process after the gasket is extruded, cut to length and spliced to the desired diameter.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

It is claimed:

1. A mechanical joint for a buried or submerged pipeline wherein the pipeline is made of ductile iron, cast iron and/or steel, the mechanical joint comprising a gasket arrangement having an annular gasket, the annular gasket having a radially outward edge portion, a radially inner edge portion, a first longitudinal edge portion and an opposite second longitudinal edge portion, the radially outward edge portion and the radially inner edge portion being generally coaxial with a gasket axis wherein the annular gasket is both annular and coaxial with the gasket axis, the radially inner edge portion having an inner engagement surface and the radially outer edge portion having an outer engagement surface, when in an installed condition, the outer engagement surface directly engaging an inner surface of a first pipe in the buried or submerged pipeline and the inner engagement surface directly engaging an outer surface of a second pipe in the buried or submerged pipeline that is adjacent to the first pipe wherein the inner and outer engagement surfaces of the annular gasket form a seal between the first and second pipes, the annular gasket includes an intrinsically conductive polymer material having a resistivity below 700 ohm-cm wherein the annular gasket both provides the seal between the first and second pipes and produces electronic current flow paths between the inner and outer engagement surfaces wherein the inner and outer engagement surfaces produce both the seal and the electrical connection between the first and second pipes thereby allowing a stray current to freely pass through the electronic current flow paths within the polymer material and between the first and second pipes to reduce and/or eliminate corrosion-induced holes.

2. The mechanical joint of claim 1 wherein the annular gasket further includes a lead in taper that helps guide the first and second pipes when the mechanical joint is pushed together.

3. The mechanical joint of claim 1 wherein the annular gasket further includes a locking flange arrangement that is shaped to engage a feature in one of the first and second pipes to secure the annular gasket relative to the one of the first and second pipes and to allow the other of the first and second pipes to be pushed into engagement with the annular gasket and form the mechanical joint.

4. The mechanical joint of claim 3 wherein the annular gasket further includes a lead in taper, the lead in taper being adjacent to the radially inner edge portion and the locking flange arrangement being in the radially outward edge portion.

5. The mechanical joint of claim 1 further including a gasket lubricant to help guide the first and second pipes into the installed condition.

6. The mechanical joint of claim 5 wherein the gasket lubricant is electrical conductivity.

7. The mechanical joint of claim 1 wherein the electronic current flow is uniform electronic current flow between substantially all of the inner and outer engagement surfaces of the annular gasket.

8. The mechanical joint of claim 1 wherein the electronic current flow is uniform electronic current flow between all portions of the inner and outer engagement surfaces that engage the respective pipes.

9. The mechanical joint of claim 1 wherein the annular gasket is formed from the intrinsically conductive polymer material and has a resistivity below 700 ohm-cm wherein the electronic current flow paths can form within the entire annular gasket such that the entire annular gasket can act as an electronic conductor which provides widely dispersed electronic current flows for the mitigation of electrolytic stray current effects on the buried or submerged pipeline.

10. The mechanical joint of claim 1 wherein the annular gasket is formed from the intrinsically conductive polymer material and the intrinsically conductive polymer material has a resistivity below 550 ohm-cm.

11. The mechanical joint of claim 1 wherein the annular gasket is formed from the intrinsically conductive polymer material and the intrinsically conductive polymer material has a resistivity below 200 ohm-cm.

12. The mechanical joint of claim 1 wherein the annular gasket is formed from the intrinsically conductive polymer material and the intrinsically conductive polymer material has a resistivity below 100 ohm-cm.

13. The mechanical joint of claim 12 wherein the intrinsically conductive polymer material has a resistivity above 50 ohm-cm.

14. The mechanical joint of claim 1 wherein substantially all of the stray current on the buried or submerged pipeline that passes between the first and second pipes passes with the intrinsically conductive polymer material of the annular gasket.

15. The mechanical joint of claim 1 wherein the annular gasket has a nominal shore A hardness in the range of 50 to 85.

16. The mechanical joint of claim 1 wherein the annular gasket has a nominal shore A hardness in the range of 50 to 65.

17. A method of controlling stray current on a buried or submerged pipeline to reduce and/or eliminate corrosion-induced holes wherein the pipeline is made of ductile iron, cast iron and/or steel, the method includes the steps of:
providing a gasket arrangement that includes an annular gasket body, the annular gasket body having a radially outward edge portion, a radially inner edge portion, a first longitudinal edge portion and an opposite second longitudinal edge portion, the radially outward edge portion and the radially inner edge portion being generally coaxial with a gasket axis wherein the annular gasket is both annular and coaxial with the gasket axis, the radially inner edge portion having an inner engagement surface and the radially outer edge portion having an outer engagement surface, the annular gasket includes an intrinsically conductive polymer material having a resistivity below 700 ohm-cm wherein the annular gasket both provides a seal between and produces electronic current flow paths;
positioning the gasket arrangement on a first pipe of the buried or submerged pipeline such that the outer engagement surface directly engages an inner surface of the first pipe and the gasket arrangement is fixed relative to the first pipe;
providing a second pipe; and,
pushing the second pipe into engagement with the gasket arrangement such that the inner engagement surface directly engages an outer surface of the second pipe wherein the second pipe is in an installed condition adjacent the first pipe and the annular gasket both providing the seal between the first and second pipes and providing electronic current flow paths between the inner and outer engagement surfaces wherein the inner and outer engagement surfaces produce both the seal and the electrical connection between the first and second pipes thereby allowing the stray current to freely pass through the electronic current flow paths within the polymer material and between the first and second pipes.

18. The method of controlling stray current of claim 17 wherein the annular gasket is formed from the intrinsically conductive polymer material that has a resistivity below 550 ohm-cm wherein the electronic current flow paths can form within the entire annular gasket such that the entire annular gasket can act as an electronic conductor which provides widely dispersed electronic current flows for the mitigation of electrolytic stray current effects on the buried or submerged pipeline.

19. The method of controlling stray current of claim 17 wherein the annular gasket is formed from the intrinsically conductive polymer material that has a generally uniform resistivity below 500 ohm-cm.

20. The method of controlling stray current of claim 17 wherein the annular gasket is formed from the intrinsically conductive polymer material that has a generally uniform resistivity below 200 ohm-cm.

21. The method of controlling stray current of claim 17 wherein the annular gasket includes the intrinsically conductive polymer material that has a resistivity below 200 ohm-cm.
